(19) United States
(12) Patent Application Publication
(10) Pub. No.: US 2025/0092325 A1
(43) Pub. Date: Mar. 20, 2025

(54) Isothermal Reverse Water Gas Shift Reactor System

(71) Applicant: Infinium Technology, LLC, Sacramento, CA (US)

(72) Inventors: James Bucher, Boston, MA (US); Matthew Caldwell, Wwat Sacramento, CA (US); Thomas P. Griffin, Cave Creek, AZ (US); Orion Hanbury, Sacramento, CA (US); Glenn McGinnis, Sun Lakes, AZ (US); Ramer Rodriguez, Sacramento, CA (US); Robert Schuetzle, Sacramento, CA (US); Jalal Zia, Aldle, VA (US)

(21) Appl. No.: 18/445,516

(22) Filed: Sep. 20, 2023

(51) Int. Cl. C10K 3/02; C01B 32/40

(52) U.S. Cl. CPC C10K 3/026; C01B 32/40

(57) ABSTRACT

The present invention is generally related to the thermal optimization of a catalytic reactor to improve its energy and conversion efficiency for the production of CO from various mixtures of CO₂ and H₂. This process involves feeding heated CO₂ and H₂ mixtures into a reverse water-gas shift (RWGS) catalytic reactor that has been designed to maintain the temperature changes of the gas mixture to within about 150° F. (preferably 100 F; most preferably 50 F) from the inlet to the outlet of the reactor. This is made possible by improved RWGS catalytic reactor designs—both to provide heat input into the reactor, and modified reaction concepts that reduce the projected temperature drop. Three major categories of temperature drop mitigation are identified; examples and subordinate approaches of each are taught. Taken singly or in any combination, these approaches make it possible to operate the reactor nearly isothermally.

### FIELD OF THE INVENTION

The field of the invention is a reverse water gas shift (RWGS) reactor that is operated in an isothermal or nearly isothermal manner and a thermal management system that facilitates the efficient conversion of CO₂ into carbon monoxide (CO) that is subsequently used in the production of synthetic fuels, chemicals and other products.

### BACKGROUND OF THE INVENTION

Carbon dioxide (CO₂) is produced by many industrial, transportation, consumer use, and biological processes, and it is usually discharged into the atmosphere. However, since CO₂ has been identified as a significant greenhouse gas, CO₂ emissions from these processes need to be reduced or recovered and the latter sequestered or reused. CO₂ can be used in enhanced oil recovery (EOR) from wells in limited applications but only a very small fraction of industrial CO₂ is used in this case. CO₂ capture and sequestration (“CCS”—similar in some ways to EOR) is being explored, but to date only small volumes of CO₂ are being sequestered underground. Thus, carbon capture and utilization (“CCU”) strategies are acutely needed as means to either recycle captured CO₂ (closing the carbon loop, achieving or approaching carbon neutrality) or transform it into non-combusted products (e.g., plastics)—with the potential for a net carbon sink, or negative carbon intensity.

One method to utilize captured CO₂ is to efficiently convert it into fuels, chemicals and other products that can displace those produced from fossil sources such as petroleum, natural gas, natural gas liquids, and other fossil fuels. In this way, the process of CO₂ capture and conversion (CCU) can lower the total net emissions of CO₂ into the atmosphere.

One reaction that has been considered as part of a broader strategy for the utilization of carbon dioxide is the Reverse Water Gas Shift (RWGS) reaction which is also referred to as carbon dioxide reduction by hydrogen.

CO₂+H₂↔CO+H₂O Eq. 1

This reaction converts carbon dioxide and hydrogen to carbon monoxide and water. This reaction is endothermic at room temperature, requiring heat to proceed. The heat of reaction (referenced to room temperature) is approximately 41 KJ/mol.

The RWGS reaction is thermodynamically favorable at temperatures of about 1,500° F. (816° C.) and above, with no theoretical impact of pressure on equilibrium (i.e., an equimolar gas phase reaction). Higher temperatures naturally result in more favorable reaction kinetics; as such, it is favorable to operate the RWGS reactor with higher inlet temperatures in the reactors. Some design requirements for an efficient RWGS reactor include:
1. High temperature operation: The RWGS reactor and catalyst system must be able to operate at high temperatures required by the reaction, typically above about 1500 F, in order to provide beneficial performance.
2. Limit the temperature decline across the catalytic bed: It is beneficial to minimize the temperature decline across the reactor bed to keep conversion of CO₂ high and to limit the production of byproducts, such as coke and methane. For purposes of this disclosure this attribute is referred to as “isothermal”—in description of the system and/or its normal operating conditions. The temperature decline across the bed, also referred to as the approach to isothermality (temperature difference), should be not more than 150 F, preferably not more than 100 F, and most preferably not more than 50 F.
3. Pressurized operation: The RWGS reactor must be able to operate at pressures that are required to operate the overall system effectively, typically between about 5 and 70 bar. Elevated pressure is also beneficial for direct integration with downstream unit operations.
4. Corrosion resistance: The RWGS reactor and catalyst system must be able to withstand the corrosive effects of the reaction, typically involving CO₂ and H₂O.
5. High selectivity: The RWGS reactor and catalyst must be able to selectively produce the desired CO product and typically a CO selectivity (or the % of CO produced from CO₂ versus other undesirable products) should be greater than 50%, but preferably greater than 70, and more preferably greater than 95%. The RWGS reactor and catalyst system should limit undesirable side reactions, such as the formation of methane and/or coke (solid carbon).
6. High conversion efficiency: The RWGS reactor and catalyst system must be able to efficiently convert CO₂ at high conversion efficiencies typically between 50%-95%.
7. Low pressure drop: The RWGS reactor and catalyst system must be designed to minimize the pressure drop across the system, typically through some combination of any/all of: the size of the reactor, reactor type, use of optimized internals, and the size, and/or shape, and/or structure of the catalyst used in the system.
8. Long lifetime: The catalyst used in the RWGS reactor should last 1 year or greater, or more preferably 3 years or greater.

There is a need in the art for novel RWGS reactor system configurations—each operated in an isothermal or nearly isothermal mode and incorporating novel thermal management systems—to address these system design requirements.

### BRIEF SUMMARY OF THE INVENTION

In one aspect, the present invention is directed to a reverse water gas shift (RWGS) process that is able to keep the reaction relatively isothermal in order to achieve beneficial performance of the system. The process involves: feeding a reactor feed stream comprising CO₂ to a reverse water-gas shift (RWGS) reactor, wherein the RWGS reactor is a catalytic reactor and wherein the RWGS reactor product stream comprises carbon monoxide and further wherein the exit carbon activity a_{c1} is less than 1.0 as described later by Equation 5.

In certain aspects regarding process: the reactor feed stream further comprises H₂, and wherein the molar ratio of hydrogen to CO₂ in the reactor feed stream is between 1.5 and 3.5, and wherein the inlet temperature for the reverse water-gas shift reactor is between 1,400-1,650° F. (780-899° C.), and in which the operating pressure of the reverse water-gas shift reactor is between 100 and 450 psig, and wherein the conversion of CO₂ from the reactor stream to the product stream is between 70 and 85 percent.

In certain aspects regarding the process: the RWGS system is kept relatively isothermal such that the differential between the inlet and the outlet temperatures is no more than +/−50 degrees F.

### BRIEF DESCRIPTION OF THE DRAWINGS

FIG. 1 shows a thermal ‘capacitance’ assisted isothermal or nearly isothermal RWGS reactor that can aid in mitigation of coking.

FIG. 2 shows equilibrium coefficients for the various coking reactions that are significant at RWGS operating conditions.

FIG. 3 shows the equilibrium coefficients for the three major coking reactions.

FIG. 4 shows a thermal capacitance assisted isothermal reactor, where hot reactants enter the top of the RWGS reactor, and gas enters an inlet distribution plenum.

FIG. 5 shows an indirect heating embodiment for the RWGS reactor system. It is a circulating fluid isothermal reactor.

FIG. 6 shows an embodiment of indirect heating via circulating heat transfer fluid. This RWGS reactor is a segmented circulating fluid isothermal reactor.

FIG. 7 shows an indirect heating embodiment using externally-supplied heat from an attached array of heaters.

FIG. 8 shows an embodiment of a directly-heated RWGS catalytic reactor system. This is a vertical heat pipe embedded isothermal reactor.

FIG. 9 shows an embodiment of a directly-heated RWGS catalytic reactor system with heat pipes. This is a horizontal heat pipe isothermal reactor.

FIG. 10 shows an embodiment of a directly-heated RWGS catalytic reactor system having an embedded heat source isothermal reactor. Heating supply sources are spread within the catalyst bed, across the cross section of the reactor(s) at various locations in the reactor.

FIG. 11 shows an embodiment of an isothermal RWGS catalytic rector system, where pressurized steam is introduced with the reactants which also has a direct inhibitory effect on coke formation.

FIG. 12 shows an embodiment of a reactor, where the reducing agent is introduced in a more distributed way over the extent of the RWGS reactors. In this case, the reactor has multiple input points down the length of the catalytic reactor.

FIG. 13 shows another embodiment of a reactor, where the reducing agent is introduced in a more distributed way over the extent of the RWGS reactors. In this case, there are multiple reactors in series, for which H₂ introduction is distributed over each reactor inlet.

FIG. 14 shows another embodiment of a reactor, where the reducing agent is introduced in a more distributed way over the extent of the RWGS reactors. This case is a hybrid configuration of the reactors of FIGS. 12 and 13.

### DETAILED DESCRIPTION OF THE INVENTION

The present invention describes an isothermal or nearly isothermal RWGS reactor configuration that achieves key design criteria including high temperature operation with minimal temperature loss, pressurized operation, high selectivity, high conversion efficiency, low pressure drops, long catalyst lifetime, and limits undesirable side reactions (including methane and coke formation).

During the RWGS operation, the temperature across the catalyst bed declines due to the endothermic nature of the reaction. This means that the reaction absorbs heat from the surrounding environment to proceed. As a result, the temperature across the catalyst bed decreases from the inlet to the outlet. Temperatures may decline by 100-500 F across the catalyst bed and such temperature decline may result in lower conversions and production of undesired side products.

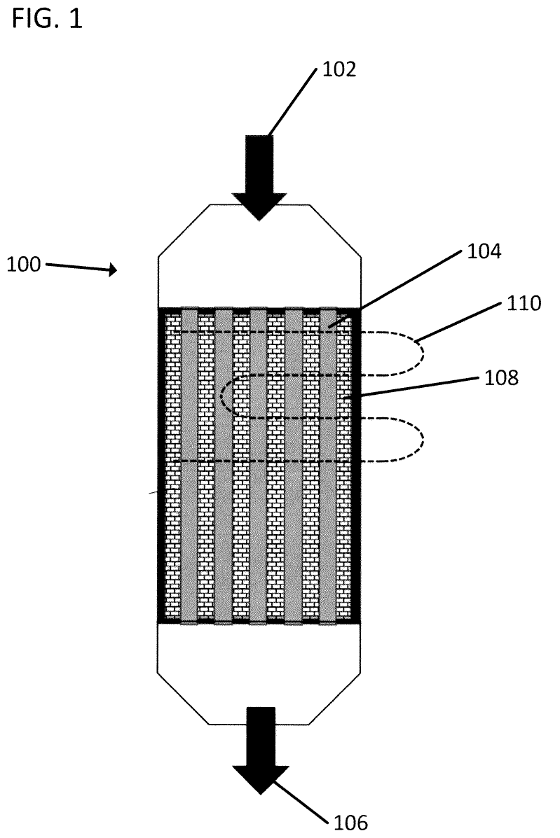

FIG. 1 shows one embodiment of a thermal capacitance assisted isothermal reactor. Hot reactants (102) enter the top of the RWGS reactor (100). The gas enters an inlet distribution plenum. The RWGS reactor is a multi-tubular reactor. The hot reactants naturally pass through each of the tubes (104) from the inlet plenum. Selective RWGS reactor catalyst is contained inside the reactor tubes. Reactant gases pass over the catalyst in the tubes and the endothermic RWGS reaction proceeds as the gases traverse the length of the tubes. The RWGS product gas or syngas (106) leaves the bottom of the tubes and enters an outlet plenum before leaving the RWGS reactor. Outside the reactor tubes are refractory bricks (108) with high thermal capacitance that provide the desired heat input (by a combination of thermal radiation and conduction). The reactor tubes do not need to mechanically contact the refractory bricks as the primary (dominant) mechanism of heat transfer is thermal radiation. All or almost all of the reactor tubes are in direct view of the refractory brick along the circumference and length. One or more electric heating coils (110) is embedded throughout the length and width of the refractory bricks. The heating coil heats the bricks only, and directly. The brick has a high heat capacity compared to the endothermic ‘flux’ of each of the reactor tubes thus anchoring the temperature of the tube wall. The tube wall temperature along the tube length is held constant or nearly constant in this embodiment. Many types of brick materials can be used. The bricks can be castable. High alumina bricks can be used or bricks containing particles or flakes of graphite or other electrically conductive materials can be used. In this design T_{delta} is preferably kept to less than 100 F, whereby the outlet temperature may be higher or lower than the inlet temperature by 100 F or less.

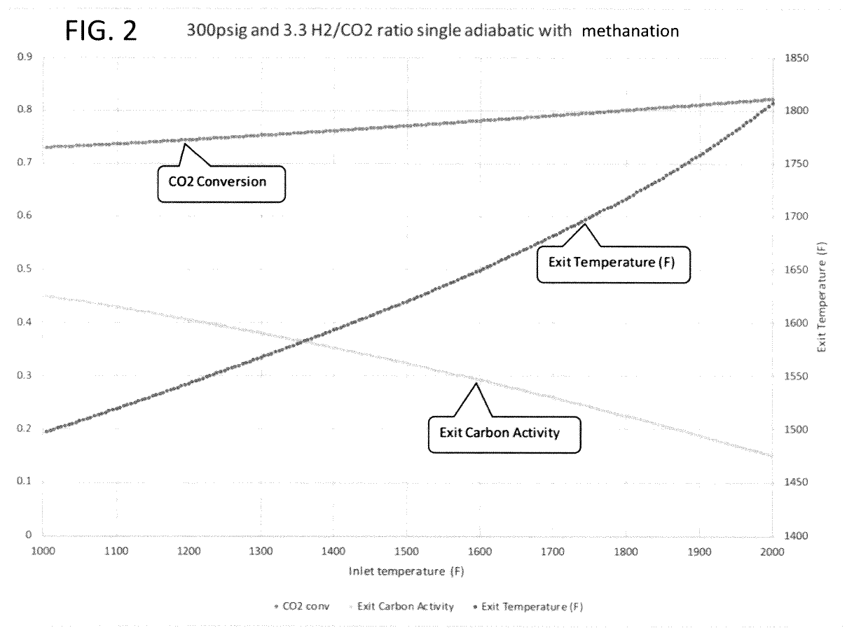

FIG. 2 is a phase diagram of several different chemical pathways used to produce coke. Suppression of coke formation and methane are of particular interest in the design and implementation of improved RWGS reactor designs. Coke is thermodynamically favored at lower temperatures for reactions involving carbon monoxide but is typically kinetically limited when temperatures are significantly elevated. If the RWGS reactor temperature is sufficiently high (greater than about 1,400° F.), coking from carbon monoxide is thermodynamically unfavorable.

A way to evaluate the thermodynamic potential to coke is via the activity coefficient for solid carbon. The carbon activity (a_{c}) for a particular carbon forming reaction is given by the Gibbs free energy relationship is given by Equation 2:

ΔG=−RT ln a_{c} Eq. 2

Thermodynamic equilibrium is achieved when the rate of coke laydown and rate of coke removal reactions are the same and would occur when ΔG=0 which happens when a_{c}=1. If a_{c}<1 then ΔG is positive and coke formation is not favorable whereas if a_{c}>1 then ΔG is negative and carbon is thermodynamically favored. Regardless of whether coke laydown or . . . coke removal is thermodynamically favorable, the kinetic rate must be sufficient to observe these reactions in a reasonable timeframe. For instance, carbon activity is far above 1 at ambient temperatures for all coking reactions, but the reactions would be so slow as to be basically non-occurring. The carbon activity is specific to solid carbon forming reactions, so for a process it is likely that there will be more than one carbon activity that needs to be evaluated to assess carbon laydown risk. For the RWGS process, the temperatures are high and the number of possible chemical compounds that contain carbon are relatively low. For this system there are three major possible coke forming reactions: carbon monoxide reduction, carbon monoxide disproportionation (the Boudouard reaction), and methane cracking.

Thermodynamic equilibrium is achieved when the rate of coke laydown and rate of coke removal reactions are the same and would occur when ΔG=0 which happens when a_{c}=1. If a_{c}<1 then ΔG is positive and coke formation is not favorable whereas if a_{c}>1 then ΔG is negative and carbon is thermodynamically favored. Regardless of whether coke laydown or coke removal is thermodynamically favorable, the kinetic rate must be sufficient to observe these reactions in a reasonable timeframe. For instance, carbon activity is far above 1 at ambient temperatures for all coking reactions, but the reactions would be so slow as to be basically non-occurring.

The carbon activity is specific to solid carbon forming reactions, so for a process it is likely that there will be more than one carbon activity that needs to be evaluated to assess carbon laydown risk. For the RWGS process, the temperatures are very high and the number of possible chemical compounds that contain carbon are relatively low. For this system there are three major possible coke forming reactions: carbon monoxide reduction, carbon monoxide disproportionation (the Boudouard reaction), and methane cracking as illustrated in FIG. 2. Methane cracking may occur if it is formed by the side reaction between CO₂ and hydrogen (the Sabatier reaction) in Equation 3:

CO₂+3H₂↔CH₄+H₂O Eq. 3

### Carbon Monoxide Reduction:

H₂+CO⇒C+H₂O Eq. 4

The carbon formation activity is given by Equation 5

$${a}_{c 1} = {K}_{1} \frac{{p}_{CO} \cdot {p}_{{H}_{2}}}{{p}_{{H}_{2} O}} \qquad Eq . 5$$

$$where$$

$$log {K}_{1} = \frac{7100}{T} - 7.496$$

In one scenario of interest, when pure H₂ and CO₂ is fed into catalytic reactor, the partial pressures of carbon monoxide and water vapor are equal. In that run, the carbon activity from carbon monoxide reduction is directly related to the hydrogen concentration and temperature alone: a_{c1}=K₁·p_{H}_{₂}. While this is a special scenario, it is common enough and can be helpful when the carbon monoxide reduction reaction is dominant.

The Boudouard reaction (carbon monoxide disproportionation) is given by Equation 6 (Grabke et al, 2007):

$$2 CO C + {CO}_{2} \qquad Eq . 6$$

$${a}_{c 2} = {K}_{2} \frac{{( {p}_{CO} )}^{2}}{{p}_{{CO}_{2}}}$$

$$where$$

$$log {K}_{2} = \frac{8817}{T} - 9.071$$

Methane cracking is shown by Equation 7 (Ginsburg et al, 2005):

$${CH}_{4} ⇒ C + 2 {H}_{2} \qquad Eq . 7$$

$${a}_{c 3} = {K}_{3} \frac{{p}_{{CH}_{4}}}{{( {p}_{{H}_{2}} )}^{2}}$$

$$where$$

$$ln {K}_{3} = \frac{- 7082.85}{T} - 32.54 - 0.003741 T + 3.61 \times 1 {0}^{- 7} {T}^{2} - \frac{35050}{{T}^{2}} + 6.5 \; 67 ln T$$

All above equations use Kelvin for temperature and bar for partial pressure. The equations assume that the carbon is deposited as an amorphous solid. Other carbon allotropes or compounds such as metal carbides might be more thermodynamically favorable than pure carbon depending on the operating conditions and may need to be independently assessed.

All carbon forming or removal reactions will potentially be occurring simultaneously. It is possible for the carbon activity of one coking pathway to be greater than one while that of the other two are less than one, thereby removing carbon more quickly than it is deposited and avoiding coking. To assess the full thermodynamic potential for carbon production for all reactions, all the carbon activities can be multiplied together to get a common carbon activity. This is only a thermodynamic treatment and respective kinetics need to be assessed in such a scenario if it is to be relied on for an engineering calculation to avoid coking.

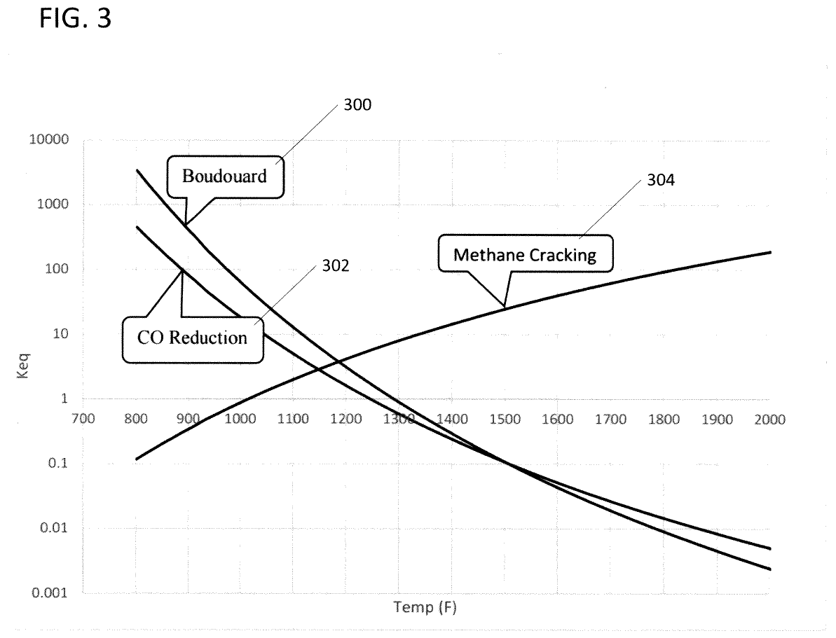

FIG. 3 shows the equilibrium coefficients for the three major coking reactions. The Boudouard equilibrium (300) is larger than the equilibrium coefficient of carbon monoxide reduction (302) until about 1500° F. (816° C.) and the methane cracking equilibrium coefficient (304) becomes larger around 1200° F. (649° C.). For scenarios in which there is a large excess of hydrogen, the carbon activity derived from these equilibrium coefficients is dominated by the carbon monoxide reduction reaction. Since the amount of methane produced tends to be low in certain RWGS catalysts with unique properties, methane cracking generally operates in the reverse direction and lifts coke to produce methane. However, in catalytic processes where methanation is a larger factor, methane cracking can become a coke producing pathway especially at high temperatures.

The combination of the three coking pathways is thermodynamically unfavorable at temperatures greater than about 1,500° F. (816° C.). If the RWGS reactor contents can be kept above this temperature throughout the entire reactor, coking is unlikely to occur.

At commercially relevant operating conditions, a reverse water gas shift (RWGS) reactor often operates under states that favor the formation of coke. These conditions occur in areas of the reactor system when the activity coefficients for coking, a_{c1} or a_{c2} or a_{c3} are greater than about 1.0.

High temperatures [>1400° F. (760° C.)] enable the desired RWGS reaction kinetically and thermodynamically, but lower temperatures are favorable for many of the undesired coking reactions. If the inlet temperature into a RWGS reactor is too low, or if the reaction conditions are highly reactive with respect to the RWGS reaction, the endothermic reaction will cause the temperature to drop into the range that is favorable for coke formation.

This invention discloses a unique isothermal or nearly isothermal RWGS reactor system that achieves a number of beneficial design criteria including limiting temperature decline across the reactor that results a temperature difference (T_{delta}) of 150 F where T_{delta} is defined as the difference between the outlet temperature (Tₒᵤₜ) and the inlet temperature (Tᵢₙ). More preferably, T_{delta} is less than 100 F, and even more preferably T_{delta} is 50 F. In this unique isothermal reactor the outlet temperature (Tₒᵤₜ) may be higher or lower than the inlet temperature (Tᵢₙ).

Three categories of approaches will be described that enable the achievement or approach to isothermal operations as defined above. These are:
1. Introduction of heat into the catalytic RWGS system indirectly—i.e., external to the reactor(s) or reactor elements containing the catalyst including but not limited to:
   a. Heated high-thermal capacity bricks (radiative dominance)
   b. Use of an indirect, heat transfer fluid (convective; with several subordinate variations)
   c. Application of external heaters—e.g., “clamshells” or other external heaters—to directly heat (by radiation and conduction) the walls of each reactor vessel or tube
2. Introduction of heat into the catalytic RWGS system directly—i.e., internal to the reactor(s) or reactor elements containing the catalyst including but not limited to:
   a. Use of “heat pipes” in the catalytic reactor vessel (with several subordinate variations)
   b. Application of Joule heating from conductors placed directly in the catalytic bed
3. Augmentation to the reaction network or sequencing that alters the quantity or density of the reaction heat effect including but not limited to:
   a. Steam addition
   b. Catalyst choice that has some degree of co-activity for both CO (endothermic) and CH4 (exothermic) production
   c. H2 staging—both intra- and inter-reactor configurations

The first category of approaches involves heat addition to the system indirectly—that is, applied externally to the vessel(s) containing the catalyst—with several possible configurations to achieve this.

This category of embodiments involves adding heat from an external source to the RWGS reactor such that the temperature does not decline significantly from inlet to exit of the reactor. With an exit temperature above 1500° F., high conversion can be achieved with low risk of producing undesirable byproducts. The coking regime can be avoided all together and the exit carbon activity, a_{c1}, is less than 1 and, more preferably, less than 0.5. Desired temperatures are maintained with a more continuous or discretized introduction of heat from outside the reactor.

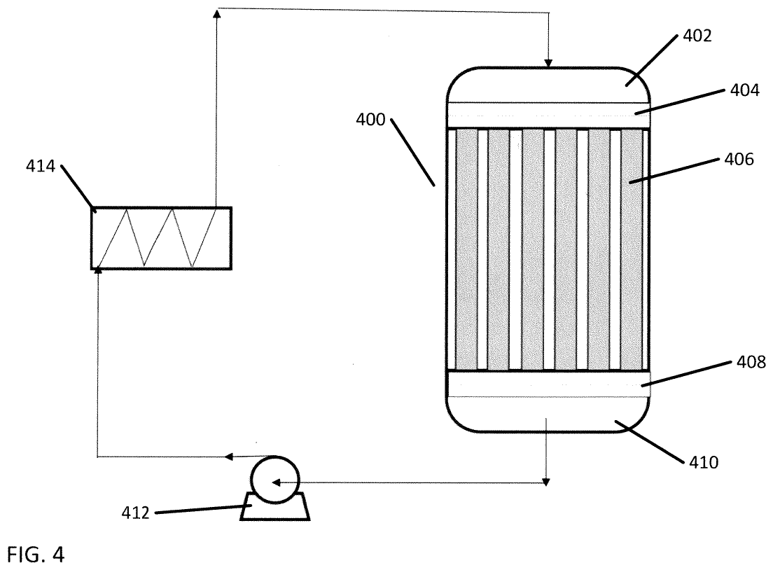

FIG. 4 shows another indirect heating embodiment for the RWGS reactor system. This is the circulating fluid isothermal reactor (400). Hot reactant gases enter the top of the reactor (402) and enter a plenum (404) or entry header where the gases are allowed to enter reactor tubes (406). The reactor tubes are filled with RWGS catalyst. The RWGS reaction occurs as the reactant gases pass over the catalyst in the tubes. The RWGS products or syngas enter an exit, plenum (408) or exit header and then exit the bottom of the reactor (410). The space between the reactor tubes is filled with a hot fluid. This hot fluid adds heat to the tubular reactors as the endothermic heat of reaction occurs. The hot thermal carrier or fluid enters the space around the catalytic tubes near the top of the reactor. As heat is transferred from the thermal fluid to the reactor tubes, the temperature of the thermal carrier or thermal fluid decreases. The cool thermal carrier leaves the bottom of the reactor. The hot thermal carrier enters the reactor at 1600° F. to 1700° F. and cools by 50-100° F. as it passes through the reactor. The pressure of the thermal carrier also declines as it passes through the reactor. The cool thermal carrier leaves the reactor, and a blower or pump (412) is used to increase the pressure of the carrier stream. In one embodiment, the cool thermal carrier is further cooled prior to the blower or pump. This cooler can be chosen from a number of coolers including a heat recovery steam generator (HRSG), waste heat boiler, or hot oil system. After the pressure of the thermal carrier fluid is increased by the blower or pump, the carrier is reheated by an electrical heater (414) that uses low carbon electricity to reheat the carrier fluid back to 1600° F. to 1700° F. prior to the hot thermal carrier fluid being sent back to the reactor. In this way, the decline of temperature in the RWGS reactor is limited. T_{delta} is from zero to 150° F., preferably from zero to 100° F., and most preferably from zero to 50° F.

The thermal carrier fluid can be chosen from a number of different fluids including argon, helium, CO2, steam, N2, air, neon, krypton, or any other suitable fluid.

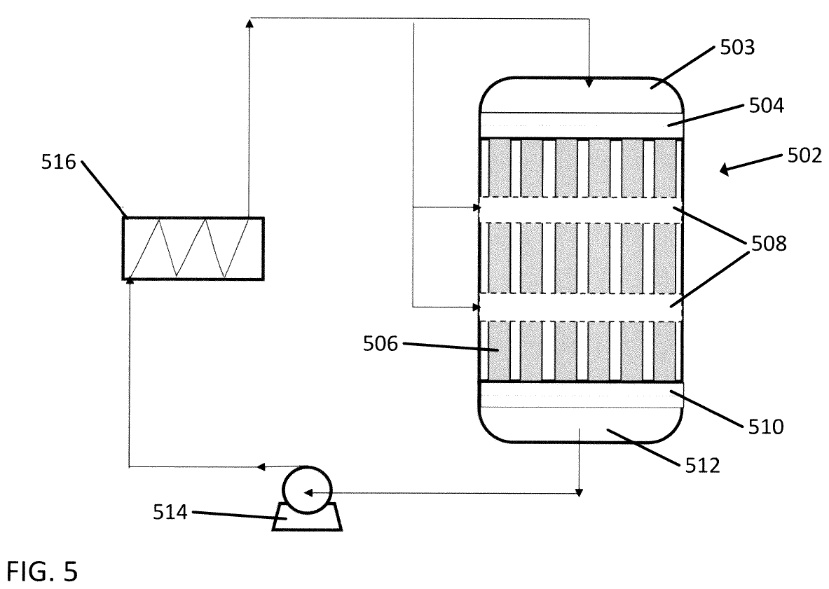

FIG. 5 shows another embodiment of indirect heating via a circulating heat transfer fluid. This RWGS reactor is a segmented circulating fluid isothermal reactor (502). Hot reactant gases enter the top of the reactor (503) and enter a plenum or entry header (504) where the gases are allowed to enter reactor tubes (506). The reactor tubes are filled with RWGS catalyst. The RWGS reaction occurs as the reactant gases pass over the catalyst in the tubes. The RWGS products or syngas enter an exit plenum or exit header (510) and then exit the bottom of the reactor (512). The space between the reactor tubes is filled with a hot fluid. This hot fluid adds heat to the tubular reactors as the endothermic heat of reaction occurs. In this embodiment, the space with the circulating thermal fluid is segmented into various sections (508). The hot thermal fluid is split into more than one inlet into each of the segmented areas outside the reactor tubes. The cooled thermal fluid also has multiple outlets and at least one outlet from each of the segmented zones. The cooled thermal fluid is re-pressurized by a blower or pump (514). Optionally, the cooled thermal fluid that still has a temperature of about 1400° F. or more can be cooled in a number of coolers including HRSG or waste heat boiler or hot oil system prior to the blower or pump. The thermal fluid is heated back to a hot temperature of 1600° F. to 1700° F. in an electrical heater (516).

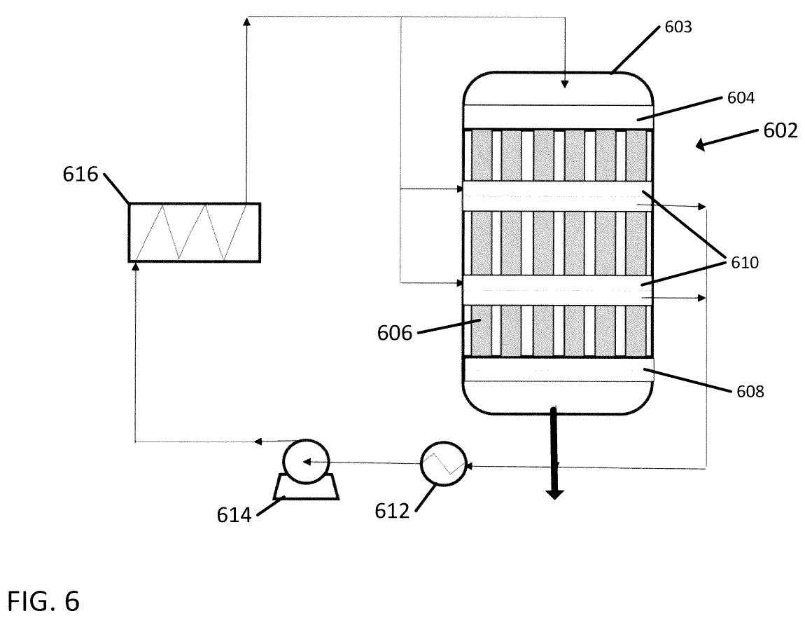

FIG. 6 shows another embodiment of indirect heating via a circulating heat transfer fluid for the RWGS reactor process and system. This is a dual cool fluid outlet circulating fluid isothermal reactor (602). Hot reactant gases enter the top of the reactor (603) and enter a plenum or entry header (604) where the gases are allowed to enter reactor tubes. The reactor tubes (606) are filled with RWGS catalyst. The RWGS reaction occurs as the reactant gases pass over the catalyst in the tubes. The RWGS products or syngas enters an exit plenum or exit header (608) and then exits the bottom of the reactor. The space between the reactor tubes is filled with a hot fluid. This hot fluid adds heat to the tubular reactors as the endothermic heat of reaction occurs. In this embodiment, there are two separate cool thermal fluid exits from the heating chamber around the reactor tubes (610). This allows for a more uniform temperature of the hot thermal fluid and better heat transfer than other configurations. The cooled thermal fluid is re-pressurized by a blower or pump (614). Optionally, the cooled thermal fluid that still has a temperature of about 1400° F. or more can be cooled in several coolers (612) including HRSG or waste heat boiler or hot oil system prior to the blower or pump (614). The thermal fluid is heated back to a hot temperature of 1600° F. to 1700° F. in an electrical heater (616). In this design T_{delta} is kept to less than 200 F, whereby the outlet temperature may be higher or lower than the inlet temperature.

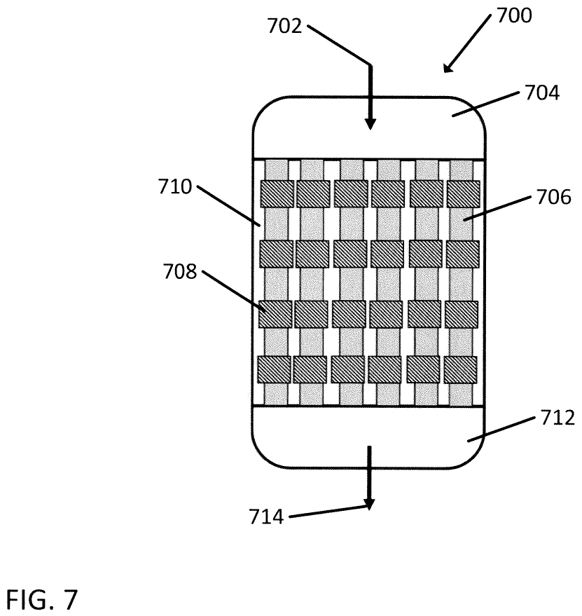

FIG. 7 shows one final embodiment in this category is the use of externally-supplied heat from an attached array of heaters—e.g., clamshell heaters, bar style heaters, or other similar types of heaters—employing both conduction and radiation to the walls of the RWGS reactor(s). Hot reactants (702) enter the top of the reactor (700) and flow into an inlet distribution plenum (704) and through reactor tubes (706) that contain reaction catalyst. The heaters (708) can be arranged in a distributed way along the length of the reactor elements, tailored to account for the highest activity at the reactor onset, while providing enough heat there to limit temperature drop and enable isothermal operations. Refractory bricks (710) with high thermal capacitance are outside the reactor tubes. Product gas leaves the bottom of the reactor through an outlet plenum (712) and then exits the reactor (714).

The second category of approaches involves heat addition to the system directly—that is, applied internally to the vessel(s) containing the catalyst-once again with several possible configurations to achieve this.

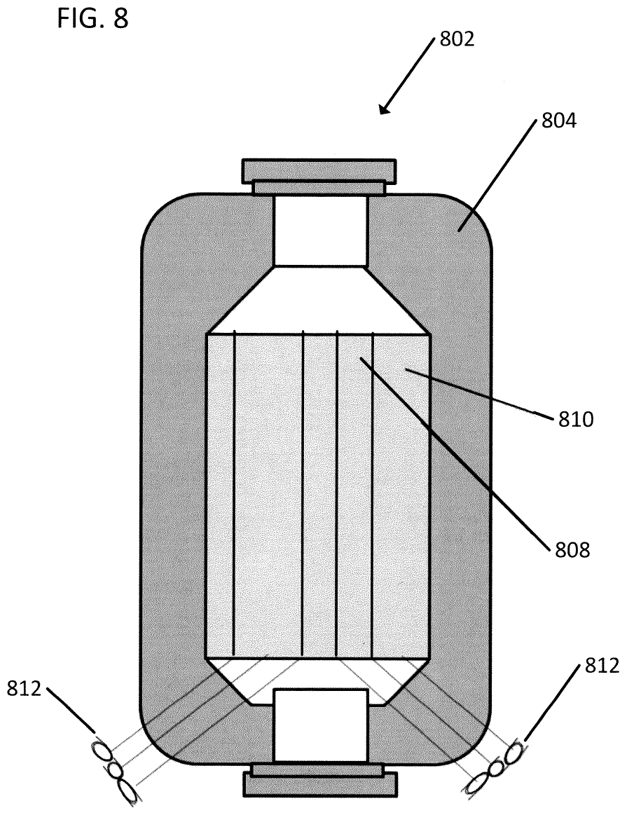

FIG. 8 shows one embodiment of a directly-heated RWGS catalytic reactor system. This is a vertical heat pipe embedded isothermal reactor (802). In this embodiment, the RWGS reactor is inside a reactor shell (804). The hot reactant gas enters the top of the reactor. The RWGS reactant gases pass over a packed bed (810) of selective RWGS catalyst. The RWGS reactor product gases leave the bottom of the packed bed and are further processed downstream of the RWGS reactor system. The packed bed has an array of vertically oriented heat pipes embedded directly in the bed (808). The heat pipes supply heat throughout the packed bed to overcome the endothermic heat of reaction of the RWGS reaction. The heat pipes are controlled by external electrical heating elements (812) outside of the RWGS reactor. The heat pipes rely on high temperature condensation of metal vapors. A common metal vapor that is useful in heat pipes is sodium at 1832° F. (1000° C.). Even at high heat flux, the heat supply temperature for the heat pipe is uniform.

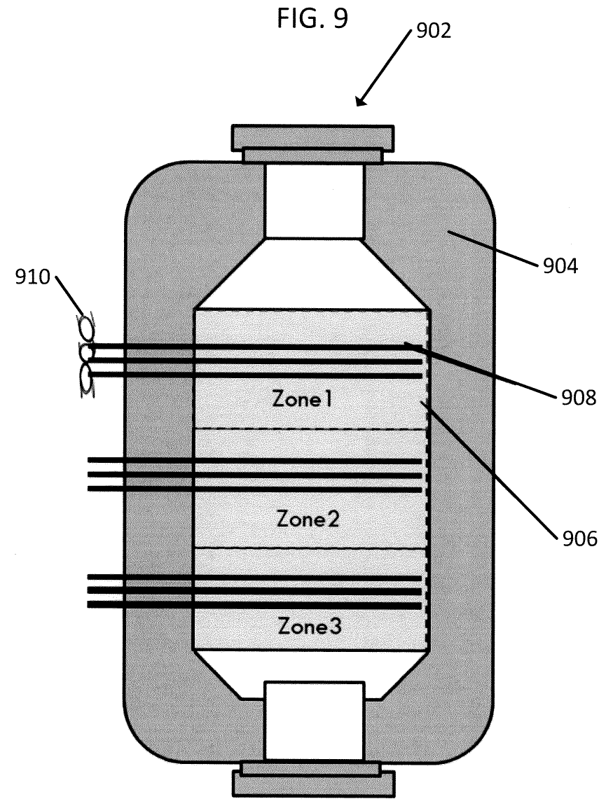

FIG. 9 depicts another embodiment in this category (direct heating) and subcategory (heat pipes). This is the horizontal heat pipe isothermal reactor (902). In this embodiment, the RWGS reactor is inside a reactor shell (904). The hot reactant gas enters the top of the reactor. The RWGS reactant gases pass over a packed bed (906) of selective RWGS catalyst. The RWGS reactor product gases leave the bottom of the packed bed and are further processed downstream of the RWGS reactor system. The packed bed has an array of zones of horizontally oriented heat pipes (908). Each zone can be configured to add a different amount of heat to optimize reactor performance. The heat pipes supply heat throughout the packed bed and the multiple zones and overcome the endothermic heat of reaction of the RWGS reaction. Shown in the figure are three zones but any number of zones can be useful. The heat pipes are controlled by external electrical heating elements outside of the RWGS reactor (910). The heat pipes rely on high temperature condensation of metal vapors. A common metal vapor that is useful in heat pipes is sodium at 1832° F. (1000° C.). Even at high heat flux, the heat supply temperature for the heat pipe is uniform. In this heat pipe type design T_{delta} is kept to less than 75 F, whereby the outlet temperature may be higher or lower than the inlet temperature.

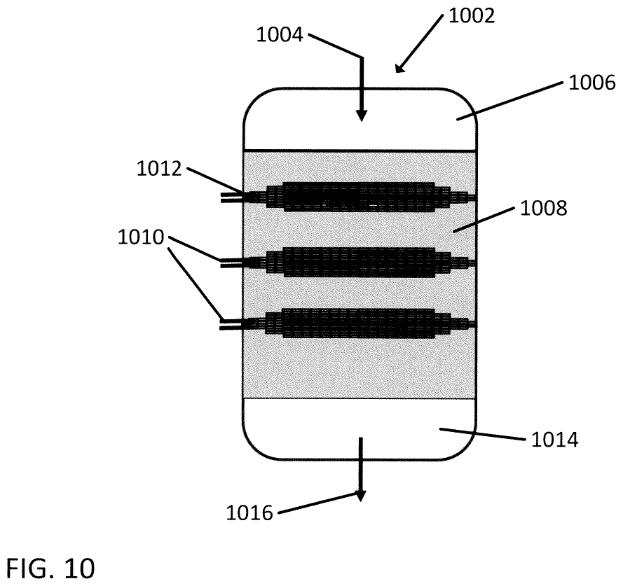

FIG. 10 shows one additional embodiment in this category is an embedded heat source isothermal reactor (1002). In this embodiment, heating supply sources are spread within the catalyst bed (1008), across the cross section of the reactor(s) at various locations in the reactor. The heating supply sources can include direct electrical (Joule) heating elements (1010). The vertical spacing of the heating supply sources can be varied to facilitate isothermal or nearly isothermal reaction along the axial length of the reactor, taking into account the expected magnitude of the endothermicity as a function of position. The heating sources have electrically isolating feed-throughs (1012) through the reactor wall. The heating sources may include clam shell electrical heaters, structured heaters that may come in a variety of shapes and sizes including cylinders, plates, star-bars, and other forms. Hot reactants (1004) enter the top of the reactor and enter an inlet plenum (1006), pass over catalyst in the catalyst bed (1008), and enter an outlet plenum (1014). Product gas or syngas (1016) exits the reactor.

The third broad category of approaches to isothermality, which is the modification of the process reaction network to offset the endothermicity of the CO₂ reduction reaction.

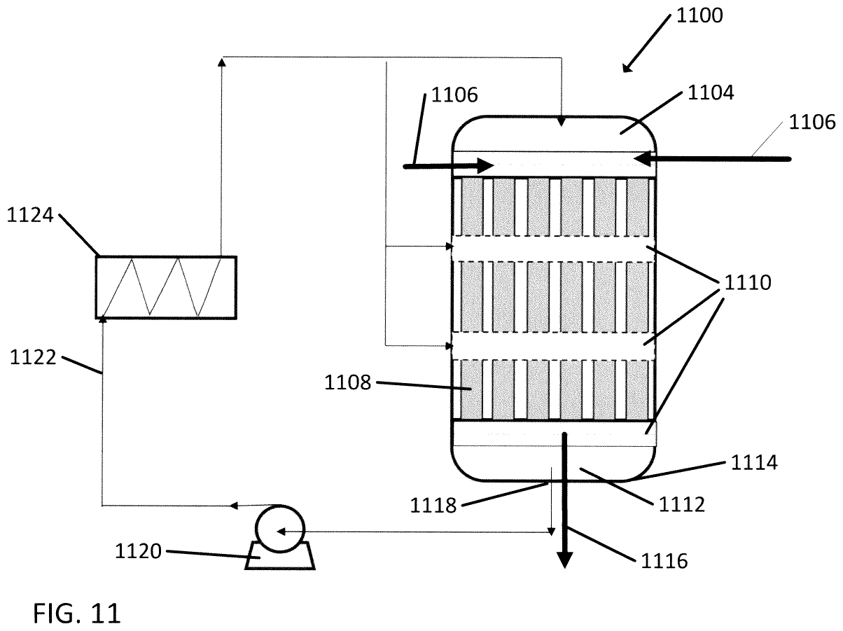

FIG. 11 shows a preferred embodiment of the RWGS system under this category, where pressurized steam is introduced with the reactants which also has a direct inhibitory effect on coke formation. This is primarily through direct Le Chatelier inhibition of the CO reduction by H₂ mechanism. Hot reactants enter the top of the reactor (1100) and enter an inlet plenum (1104) where pressurized steam is introduced. (1106). The reactants and steam enter reactor tubes (1108), which are filled with RWGS catalyst. Spaces (1110) are shown between sets of reaction tubes. RWGS products or syngas enter an exit plenum or exit header (1112), exit the bottom of the reactor (1114) and proceed to further processing (1116). Thermal fluid used to heat catalyst tubes flows through an outlet (1118) and is repressurized by a blower or pump (1120). The repressurized fluid (1122) is heated back to a hot temperature of 1600° F. to 1700° F. in an electrical heater (1124).

Steam injection is easily implementable and has several benefits. Steam addition can be deployed in small increments as a kind of tuning parameter. Steam injection is used to reverse coke formation and can work with a rapid response time. Steam addition has three major impacts that reduce carbon activity: (1) It has a direct impact on the carbon activity of the dominant carbon monoxide reduction reaction which reduces the carbon activity. (2) It reduces the equilibrium conversion of the RWGS reactor and limits the extent of the endothermic RWGS reaction to help lessen the drop in temperature. (3) It also adds thermal mass to the system, dampening temperature decline in that way.

Note that the H₂/CO ratio of the RWGS product goes up as steam is added to the RWGS reactor. The downstream use of the RWGS product gas is ideally met with a H₂/CO ratio close to 2.0 when fuel production is the target end product; thus, steam addition can then help offset part of the net requirement for green H₂ production.

In a preferred embodiment of the RWGS system, CO₂ conversion efficiency achieved is greater than 60%, more preferably greater than 75% and even more preferably greater than 80%. Selectivity to CO, while minimizing production of side products such as methane and coke, is ideally greater than 80%, more preferably greater than 90% and even more preferably greater than 95%.

Catalyst selection for use in the RWGS reactor is key to achieving desired results. One preferred catalyst used in the RWGS reactor is a selective catalyst with no or very little amounts of transition metals. One example of such a catalyst is an unsupported Ni2Mg solid solution catalyst. This base case catalyst catalyzes the reverse water gas shift (RWGS) reaction and does not promote any other chemical reaction. However, improved, and alternative catalysts have been developed that comprise the addition of transition metals.

Catalysts can include multiple components of different functionality. Catalysts may be monofunctional, bifunctional or multifunctional formulations comprising many different elements including nickel, magnesium, aluminum, iron, copper, cobalt, indium, sodium, silicon, manganese, zinc, chromium, rhodium, carbon, cerium, titanium, and zirconium. Specifically, catalysts include unsupported Ni2Mg solid solution catalyst, Mg/Mg-aluminate catalyst, Rhodium on gamma alumina, CuFeO2, Fe—Co/K/Al2O3, In2O3/HZSM-5, Na—Fe3O4/HZSM-5, NaFe2O4/HMCM-22, Fe2O3, Co6/MnO4, Zn—Cr/Hy, Fe—Zn—Zr/HZSM-5, and Fe—Mn—K.

In another embodiment in this category, an improved catalyst, unsupported Ni2Mg solid solution, also, to some degree, catalyzes the methanation reaction:

3H₂+CO=CH₄+H₂O

The methanation reaction is exothermic and generates heat. The improved catalyst allows the formation of methane to keep the temperature elevated in the RWGS reactor bed with little or no external heat requirement.

Because of the nature of the coking reactions, however (including their propensity to be thermodynamically controlled, and to proceed either homogeneously or on many effectively catalytic services of importance)—this approach provides a potential preferred embodiment to avoid the “coking allowed” temperature regime altogether. This involves keeping the RWGS reactor at temperatures above the “coking allowed” operating regime. In this example, the catalyst deliberately enables some controlled degree of co-reaction (methanation) that carries offsetting heat effects relative to the RWGS—i.e., have exothermicity that can somewhat offset the temperature drop that the endothermic RWGS which would otherwise cause.

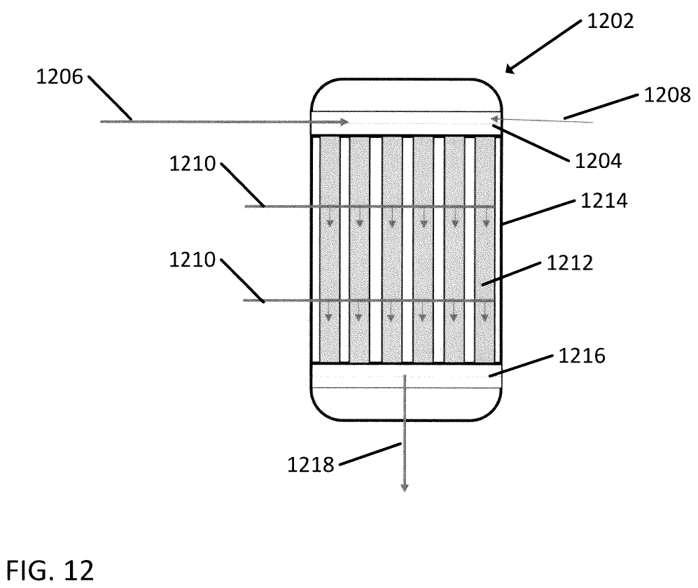

In another embodiment in this category, the reducing reagent—H2—is introduced in a more distributed way over the extent of the RWGS reactors, and beyond. This keeps the desired activity of H2 at a lower average level, which minimizes its tendency to reduce CO (contributing directly to coke) in a parallel, competing reaction. This can be put into practice, as shown in FIGS. 12-14.

FIG. 12 shows a reactor (1202) having multiple input points down the length of the catalytic reactor. Hot reactants (1206) enter an inlet plenum (1204) of the reactor along with the reducing agent (hydrogen, 1208). The resulting mixture is introduced to reactor tubes (1212) containing catalyst. Other inlet points (1210) provide the reducing agent down the length of the catalytic reactor. Refractory bricks (1214) with high thermal capacitance provide the desired heat input. Product gas or syngas enters the outlet plenum (1216) and exits the bottom of the reactor (1218).

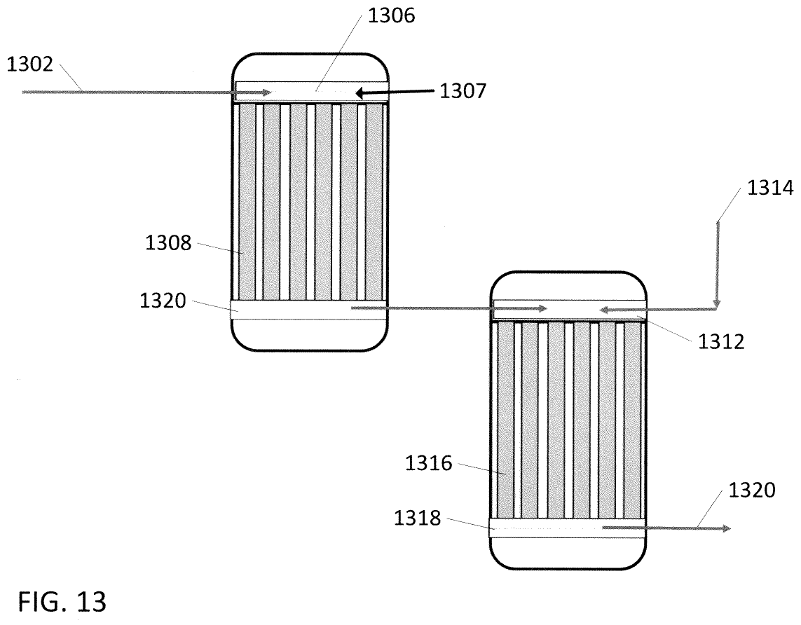

FIG. 13 shows multiple reactors in series, for which H2 introduction is distributed over each reactor inlet. Hot reactants (1302) enter an inlet plenum (1306) along with the reducing agent (hydrogen, 1307). The resulting mixture is introduced to reactor tubes (1308) and product gas or syngas enters the outlet plenum (1320) and subsequently exits the reactor and enters the inlet plenum (1312) of a second reactor. Reducing agent (1314) is added to the product gas or syngas, which is introduced into reactor tubes (1316). This second product gas or syngas enters the outlet plenum of the second reactor (1318) and then exits the second reactor (1320).

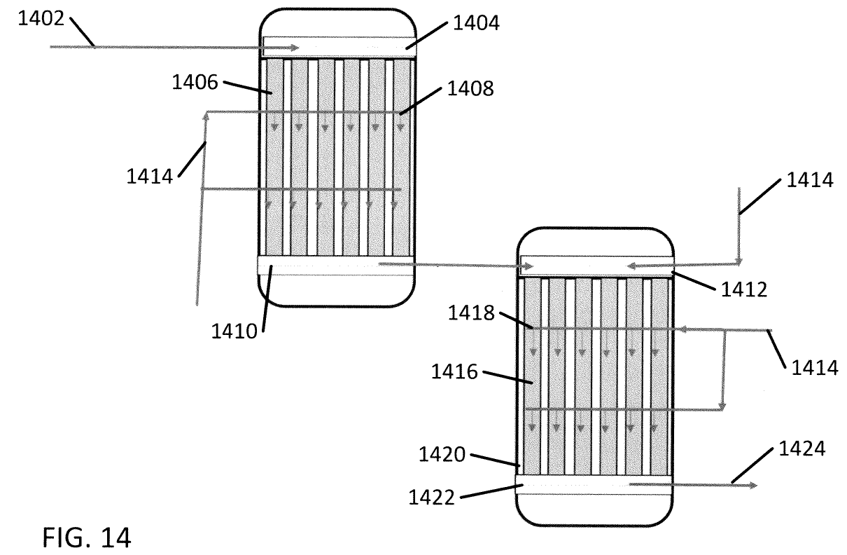

FIG. 14 shows a hybrid configuration of the reactors of FIGS. 12 and 13. Hot reactants (1402) enter an inlet plenum (1404) and subsequently are introduced to reactor tubes (1406) containing RWGS catalyst. Reducing agent (hydrogen, 1414) is introduced through inlet points (1408), which provide the reducing agent down the length of the catalytic reactor. Product gas or syngas enters the outlet plenum (1410), exits the reactor and is provided to an inlet plenum (1412) of a second reactor, where it is mixed with reducing agent (hydrogen, 1414). The resulting mixture is introduced to reactor tubes (1416) containing RWGS catalyst. Additional reducing agent can be provided through second inlet points (1418). Refractory bricks (1420) with high thermal capacitance provide the desired heat input. Product gas or syngas enters the outlet plenum (1422) and exits the bottom of the reactor (1424).

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter within this disclosure are contemplated as being part of the inventive subject matter disclosed herein.

Still other aspects, examples, and advantages of these exemplary aspects and examples and embodiments, are discussed in detail. Moreover, it is to be understood that both the foregoing information and the following detailed description are merely illustrative examples of various aspects and are intended to provide an overview or framework for understanding the nature and character of the claimed aspects and examples. Any example disclosed herein may be combined with any other example in any manner consistent with at least one of the objects, aims, and needs disclosed herein, and references to “an embodiment”, “exemplary embodiment”, “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### REFERENCES

U.S. Pat. No. 8,841,839
U.S. Pat. No. 8,846,717
US Pub. Appl. No. US20200238258A1
US Pub. Appl. No. US20210340077A1
US Pub. Appl. No. US20210340015A1
US Pub. Appl. No. US20210340075A1
US Pub. Appl. No. US20210340076A1

1. A process for the production of a first product stream comprising carbon monoxide, wherein the process comprises feeding a first reactor feed stream comprising carbon dioxide to a Reverse Water Gas Shift reactor, wherein the Reverse Water Gas Shift reactor has an inlet and an outlet, and wherein the inlet has an inlet temperature and the outlet has an outlet temperature, and wherein the inlet temperature and the outlet temperature are within 0 to 150° F. of one another, and wherein the Reverse Water Gas Shift Reactor is indirectly heated, and wherein the Reverse Water Gas Shift reactor comprises a catalyst that converts carbon dioxide to carbon monoxide, thereby producing the first product stream.

2. The process according to claim 1, wherein the Reverse Water Gas Shift Reactor is a thermal capacitance assisted isothermal reactor.

3. The process according to claim 1, wherein the Reverse Water Gas Shift Reactor is a circulating fluid isothermal reactor.

4. The process according to claim 1, wherein the Reverse Water Gas Shift Reactor is a segmented circulating fluid isothermal reactor.

5. The process according to claim 1, wherein the Reverse Water Gas Shift Reactor is a dual cool fluid outlet circulating fluid isothermal reactor.

6. The process according to claim 1, wherein the Reverse Water Gas Shift Reactor has one or more walls, and wherein an array of heaters provides heat to the walls through both conduction and radiation.

7. The process according to claim 2, wherein the inlet temperature and the outlet temperature are within 0 to 100° F. of one another.

8. The process according to claim 2, wherein the Reverse Water Gas Shift Reactor comprises reactor tubes, and wherein the catalyst is within the tubes, and wherein there are refractory bricks outside of reactor tubes that do not contact the reactor tubes, and wherein one or more electric heating coils are embedded in the refractory bricks.

9. The process according to claim 3, wherein the Reverse Water Gas Shift Reactor comprises reactor tubes, and wherein the catalyst is within the tubes, and wherein there are spaces between the reactor tubes, and wherein the spaces include a thermal fluid, and wherein heat is transferred from the thermal fluid to the reactor tubes.

10. The process according to claim 4, wherein the Reverse Water Gas Shift Reactor comprises reactor tubes, and wherein the catalyst is within the tubes, and wherein there are spaces between the reactor tubes, and wherein the spaces include a thermal fluid, and wherein the spaces are segmented into various sections outside the reactor tubes, and wherein heat is transferred from the thermal fluid to the reactor tubes.

11. The process according to claim 5, wherein the Reverse Water Gas Shift Reactor comprises reactor tubes, and wherein the catalyst is within the tubes, and wherein there are spaces between the reactor tubes, and wherein the spaces include a thermal fluid, and wherein heat is transferred from the thermal fluid to the reactor tubes, and wherein the reactor tubes are within a heating chamber, and wherein there are two separate thermal fluid exits from the heating chamber.

12. The process according to claim 6, wherein the heaters are clamshell heaters or bar style heaters.

13. The process according to claim 8, wherein the refractory bricks are either high alumina bricks of contain particles or flakes of electrically conducting material.

14. The process according to claim 9, wherein the thermal fluid is argon, helium, CO2, steam, N2, air, neon or krypton.

15. The process according to claim 10, wherein the thermal fluid is argon, helium, CO2, steam, N2, air, neon or krypton.

16. The process according to claim 11, wherein the thermal fluid is argon, helium, CO2, steam, N2, air, neon or krypton.

17. The process according to claim 11, wherein the first product stream has an exit carbon activity, and wherein the exit carbon activity ranges from 0 to 1.0, and wherein there is a pressure drop between the inlet and outlet, and wherein the pressure drop ranges from 0 psig to 50 psig.

18. The process according to claim 12, wherein the first product stream has an exit carbon activity, and wherein the exit carbon activity ranges from 0 to 1.0, and wherein there is a pressure drop between the inlet and outlet, and wherein the pressure drop ranges from 0 psig to 50 psig.

19. The process according to claim 13, wherein the first product stream has an exit carbon activity, and wherein the exit carbon activity ranges from 0 to 1.0, and wherein there is a pressure drop between the inlet and outlet, and wherein the pressure drop ranges from 0 psig to 50 psig.

20. The process according to claim 14, wherein the first product stream has an exit carbon activity, and wherein the exit carbon activity ranges from 0 to 1.0, and wherein there is a pressure drop between the inlet and outlet, and wherein the pressure drop ranges from 0 psig to 50 psig.

21. The process according to claim 15, wherein the first product stream has an exit carbon activity, and wherein the exit carbon activity ranges from 0 to 1.0, and wherein there is a pressure drop between the inlet and outlet, and wherein the pressure drop ranges from 0 psig to 50 psig.

22. The process according to claim 16, wherein the first product stream has an exit carbon activity, and wherein the exit carbon activity ranges from 0 to 1.0, and wherein there is a pressure drop between the inlet and outlet, and wherein the pressure drop ranges from 0 psig to 50 psig.

23. The process according to claim 17, wherein the first product stream has an exit carbon activity, and wherein the exit carbon activity ranges from 0 to 1.0, and wherein there is a pressure drop between the inlet and outlet, and wherein the pressure drop ranges from 0 psig to 50 psig.

24. A process for the production of a first product stream comprising carbon monoxide, wherein the process comprises feeding a first reactor feed stream comprising carbon dioxide to a Reverse Water Gas Shift reactor, wherein the Reverse Water Gas Shift reactor has an inlet and an outlet, and wherein the inlet has an inlet temperature and the outlet has an outlet temperature, and wherein the inlet temperature and the outlet temperature are within 0 to 150° F. of one another, and wherein the Reverse Water Gas Shift Reactor is directly heated, and wherein the Reverse Water Gas Shift reactor comprises a catalyst that converts carbon dioxide to carbon monoxide, thereby producing the first product stream.

25. The process according to claim 24, wherein the Reverse Water Gas Shift reactor is a vertical heat pipe embedded isothermal reactor or a horizontal heat pipe embedded isothermal reactor, wherein the vertical heat pipe embedded isothermal reactor comprises one or more vertical heat pipes and the horizontal heat pipe embedded reactor comprises one or more horizontal heat pipes.

26. The process according to claim 24, wherein the Reverse Water Gas Shift reactor is an embedded heat source isothermal reactor.

27. The process according to claim 25, wherein the Reverse Water Gas Shift reactor is inside a reactor shell.

28. The process according to claim 25, wherein the Reverse Water Gas Shift catalyst is within a packed bed.

29. The process according to claim 25, wherein the inlet temperature and the outlet temperature are within 0 to 75° F. of one another.

30. The process according to claim 26, wherein there is a catalyst bed, and wherein heating supply sources are spread within the catalyst bed.

31. The process according to claim 28, wherein the one or more vertical heat pipes or the one or more horizontal heat pipes are controlled by external heating elements that supply heat to the packed bed, and wherein heat from the condensation of metal vapors provides heat to the external heating elements.

32. The process according to claim 30, wherein the heating supply sources include Joule heating elements.

33. The process according to claim 30, wherein the heating supply sources are spaced vertically to provide spaces, and wherein the spaces are varied to facilitate isothermal reactions in the reactor.

34. The process according to claim 30, wherein the Reverse Water Gas Shift Reactor has a wall, and wherein the heating supply sources have electrically isolating feed-throughs through the reactor wall.

35. A process for the production of a first product stream comprising carbon monoxide, wherein the process comprises feeding a first reactor feed stream comprising carbon dioxide to a Reverse Water Gas Shift reactor, wherein the Reverse Water Gas Shift reactor has an inlet and an outlet, and wherein the inlet has an inlet temperature and the outlet has an outlet temperature, and wherein the inlet temperature and the outlet temperature are within 0 to 150° F. of one another, and wherein pressurized steam is fed into the Reverse Water Gas Shift Reactor in addition to the first reactor feed stream, and wherein the Reverse Water Gas Shift reactor comprises a catalyst that converts carbon dioxide to carbon monoxide, thereby producing the first product stream.

36. The process according to claim 35, wherein there is a CO2 conversion efficiency associated with the production of the first product stream, and wherein the CO2 conversion efficiency is between 60 percent and 100 percent.

37. The process according to claim 35, wherein the Reverse Water Gas Shift reactor catalyst also catalyzes a methanation reaction, and wherein the methanation reaction is an exothermic reaction, and wherein the heat from the exothermic reaction offsets the temperature drop produced by the conversion of carbon dioxide to carbon monoxide.

38. The process according to claim 35, wherein hydrogen is fed into the Reverse Water Gas Shift reactor along with the first reactor stream.

39. The process according to claim 38, wherein the hydrogen fed into the Reverse Water Gas Shift reactor is fed through multiple inlet points.
